(19) United States
(12) Patent Application Publication
(10) Pub. No.: US 2006/0238491 A1
(43) Pub. Date: Oct. 26, 2006

(54) Design for a computer pointing device

(76) Inventor: Won Moo Song, Haltom City, TX (US)

Correspondence Address: CARSTENS & CAHOON, LLP, P O BOX 802334, DALLAS, TX, 75380, US

(21) Appl. No.: 11/111,232

(22) Filed: Apr. 21, 2005

(51) Int. Cl. G09G 5/00

(52) U.S. Cl. 345/156

(57) ABSTRACT

An improved computer pointing device includes improved button placement, adjustable wrist support, and a guide for elevating the mouse cord above the user's hand. The buttons are placed to engage a proximal portion of the user's fingers. A wrist support is provided that relieves the tension on the wrist. The wrist support can move relative to the body of the mouse. The position of control buttons on the upper surface can be adjusted to conform to a user's hand size. Alternative buttons can be placed on a side surface so that the user can rest his index and middle fingers and use the thumb occasionally.

### TECHNICAL FIELD OF THE INVENTION

The present invention relates to an improved design for a computer pointing device. Each design provides a more ergonomic and useful pointing device (or “mouse”), particularly for those who experience hand and wrist pain from the use of common designs.

### BACKGROUND OF THE INVENTION

The computer pointing device has revolutionized the use of computers. It has allowed the user to quickly select commands from pull down menus, cut and paste content, and so many other dramatic improvements. The original mouse was not designed to be very ergonomic. It was sized to fit into the palm of a user's hand. It usually had one or two buttons that were depressed with the tips of the user's fingers. It recorded position using a track ball on the underside that rolled in response to the user's hand movements. Relatively recent improvements include the elimination of the track ball in favor of optical tracking. Another improvement is a wireless mouse that eliminates the cord coupling the mouse to the computer.

One of the drawbacks of the basic mouse design is that it promotes wrist and hand injuries due to poor ergonomics. These injuries can be traced to several specific design flaws: (1) the position of the control buttons, (2) the inability to adjust the size or configuration of the mouse to customize it for the user; (3) the position of the cord connecting the mouse to the computer, and (4) the inability to have buttons positioned to allow the same function be accomplished by buttons in distinctly different positions on the mouse.

The standard mouse requires that the user use his finger tips to activate the buttons on the mouse. Typically the user uses his index and middle fingers to activate the buttons. Each finger (except the thumb) has three bones or phalanges. This creates three distinct portions to each finger which will be referred to as the distal, middle and proximal portions. Each finger has a pad of soft tissue under the skin. This soft tissue contains nerve endings. The constant impact of the distal portions of the fingers on keyboards and mouse buttons compresses the soft tissue. Over time, this irritates the nerve endings and creates numbness or pain in the finger tips. Therefore a need exists for moving the mouse buttons to a position under another portion of the finger.

Mouse designs also tend to create wrist injuries over time. While the mouse is sized to fit into the user's palm, the user is expected to suspend his wrist parallel to the work surface. Specially designed “mouse pads” exist with integrated wrist pads. However, as the user moves the mouse with his hand, his wrist is moved away from the support. Thus, mouse pads do not provide the needed relief.

The cord connecting the mouse to a computer also provides an unwanted force to the user's hand. The cord tends to drag across the work surface. This produces an unwanted torque on the mouse and requires the user to balance that torque with his wrist muscles. A need exists to minimize the torque produced by cord.

Finally, the constant repetition of motion by the user contributes to the risk of wrist and hand injury. Even while typing, a user will begin to sense the discomfort building in his hands and wrists. For applications that are particularly mouse-intensive, the user has no choice but to continue with the repetitious motion. A need exists to provide for a variety of buttons on a mouse that accomplish the same function. This would allow the user to at least choose to add variety to his motion and minimize the strain on his hands.

### SUMMARY OF THE INVENTION

The present invention overcomes many of the disadvantages found in the prior art. Specifically, the mouse alleviates the repetitive stress in the finger tips by placing the mouse buttons in a position under the proximal portion of the finger. The mouse can also alleviate wrist injury by placing utilizing an integrated wrist pad. The wrist pad is adjustable to fit a particular user's hand. For example the pad can be moved further away from the mouse and can pivot in response to the user's wrist motion.

In one embodiment, the power cord to the mouse is located in the center of the upper surface of the mouse. This reduces the drag and torque experienced by the mouse. This is facilitated by the use of a rigid guide that directs the cord above the user's hand. To reduce drag further, the guide can also have a horizontal portion that extends the cord beyond the user's hand. Finally, the guide could be secured into a slot when not is use.

Another innovation of the present invention is the use of an alternative button to accomplish the same task as one of the primary buttons on the upper surface of the mouse. This would allow a user to alternate between a first and second choice for accomplishing the same task.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1A is side view of a user using a computer pointing device having button placement in accordance with the present invention;

FIG. 1B shows a top view of the pointing device of FIG. 1A;

FIGS. 2A, 2B and 2C illustrate a means for coupling a cord to the mouse to minimize the amount of drag and torque experienced by the user;

FIGS. 3A and 3B illustrate a mouse with an adjustable and integrated wrist pad; and

FIG. 4 illustrates a mouse having control buttons whose position can be adjusted; and

FIGS. 5A, 5B and 5C illustrate various embodiments with non-traditional button placement.

### DETAILED DESCRIPTION OF THE DRAWINGS

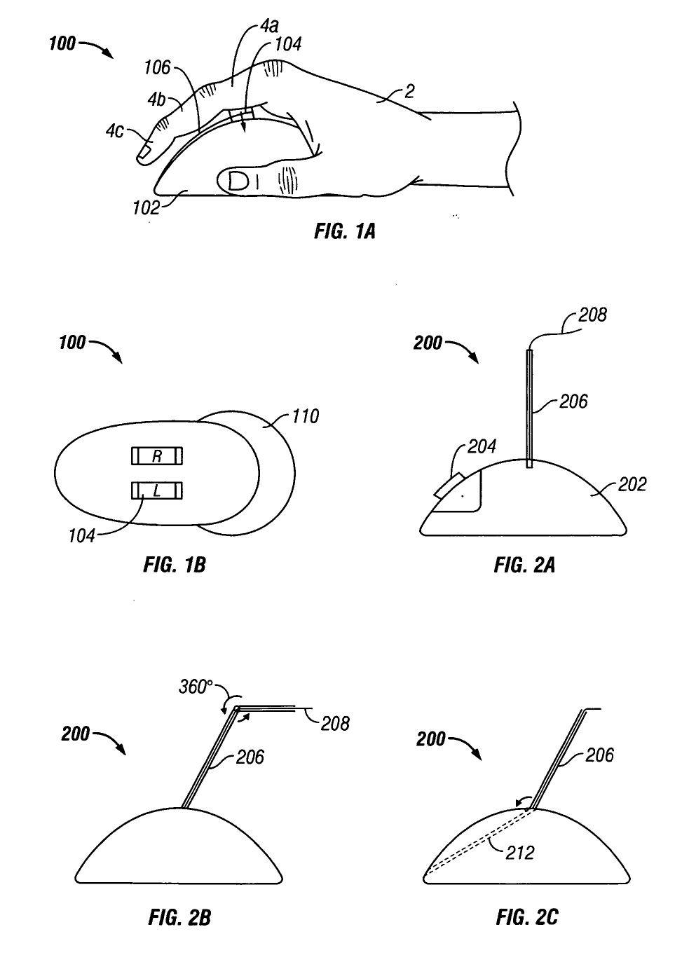

Referring to FIG. 1A, a computer pointing device 100 is shown that embodies the present invention. The computer pointing device, also known as a “mouse”, is used to manipulate the position of a cursor on a computer monitor. The user 2 moves the mouse across a flat work surface and its movement is translated into movement of the cursor on the user's computer monitor. However, using a mouse for an extended period of time can cause injury to the user's fingers and wrist. In this instance, the mouse has an upper surface 102. At least one button 104 is located on the upper surface. The button 104 is used to control some specific function. For instance, while movement of the mouse will move the cursor on the monitor, it will not highlight a portion of text to cut and paste. However, the button can be pressed once to begin highlighting and again to end the highlighting function. Once highlighted, text can be cut and pasted in another location.

Note that the user's index finger 4 has three segments, proximal segment 4a, middle segment 4b, and distal segment 4c. Button 104 can be placed under the middle segment 4b or preferably under the proximal segment 4a. This reduces the trauma experienced by the repetitive use of the distal segment. The middle and proximal segments can endure more repetition because of the increased amount of soft tissue on those segments.

FIG. 1B shows a top view of the same pointing device shown in FIG. 1A. The pointing device 100 has an integrated wrist pad 110. Also, it incorporates two control buttons, designated L and R for left and right. The user places his hand atop the pointing device so that his index finger and middle finger rest atop the control buttons 104 and his wrist atop pad 110.

FIG. 2A illustrates another novel improvement for a mouse 200, namely the placement of the connection cord to the middle of the upper surface 202. This cord 208 provides both power to the mouse and connectivity with the computer. However, by placing the connection point near the center of the upper surface, the amount of drag and torque experienced by the user is minimized. In order to lift the cord out of the way of the user's hand, a guide 206 can be used. The guide must be rigid enough to support the weight of the cord 208. It must also be long enough to lift the cord above the user's hand. A button 204 can still be placed in a standard position or the modified position of FIG. 1A. In use, the guide 206 would rest between the user's index finder and middle finger.

FIG. 2B shows a similar arrangement with a guide 206 lifting the cord 208 above the mouse 200. An additional swivel portion 210 further guides the cord 208 beyond the user's hand. In FIG. 2C, the mouse has a slot 212 for accepting the guide 206. Thus, when the mouse is not in use, the guide can be folded into the slot and out of the way. Indeed, the slot 212 can guide the cord 208 to the front of the mouse, which is similar to its position on other computer pointing devices.

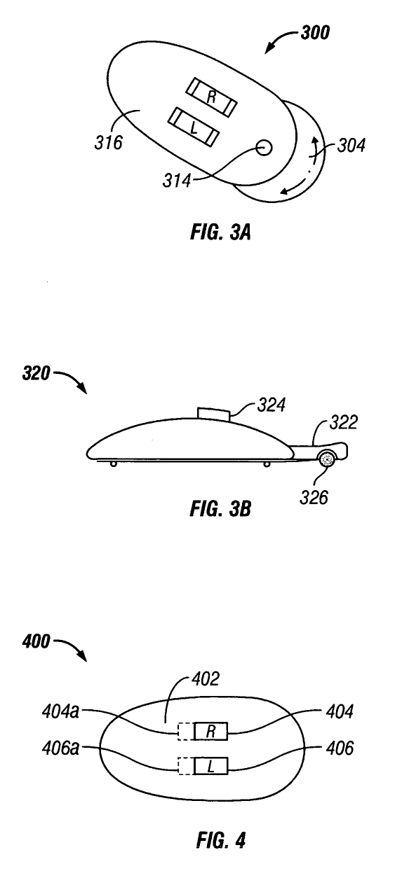

Another area of improvement involves support of the user's wrist and forearm. A standard mouse only fits within the palm of the user. It provides no support for the wrist. Thus, the wrist is lifted using the muscles on the top of the forearm. These muscles remain in tension during use and eventually tire. Mouse pads with integrated wrist supports however are inadequate for two reasons. First, they fail to adjust with the user's movements. Second, they fail to adjust based on the size of the user. FIG. 3A details a pointing device 300 having an integrated wrist support 304 that is connected to the pointing device. The wrist support can pivot about point 314 so that the user can comfortably support his wrist, even while moving the pointing device 300.

FIG. 3B provides a side view of the device 300. In this instance, the wrist support can pivot relative to the mouse body around pivot point 314. The user's wrist is fully supported while he manipulates the mouse 310 and uses buttons 316. One problem with extending the footprint of the mouse is increasing the amount of drag between the mouse and the work surface. One solution 320 is providing a roller 326 on the underside of the wrist support 322. This allows the mouse to be more easily moved about the work surface. Note that this figure does not show the use of any cord to couple the mouse to the computer. Instead, this embodiment is coupled wirelessly to the computer.

Another solution is shown in FIG. 4. In this instance, the mouse 400 is equipped with adjustable buttons 404, 406. In other words, the location of the buttons can be adjusted to conform to the user's needs. For a user with longer fingers, the buttons can be moved to a forward position 404a, 406a. In accordance with the concepts set forth with FIGS. 1A and 1B, the buttons would be positioned so that they fall under the user's proximal finger section. The buttons can be positioned in a track that allows this movement. A locking means can be employed to hold the buttons in place. For example, a latch could be used that is engaged when they mouse is in an upright position. The latch could disengage, allowing repositioning, when the mouse was in another position.

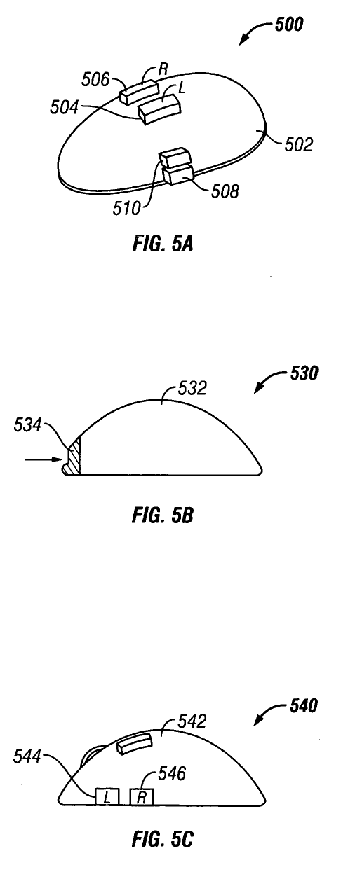

Another issue with the ergonomics of a mouse relates to button placement as it relates to the user's hand position. A mouse user usually holds his hand so that the palm is in a substantially horizontal plane. The fingers then drape downward, with the thumb pressing or resting against the side of the mouse. The wrist and finger tips can have some relief by providing the user with other options. For example, in FIG. 5A, the mouse 500 has an upper surface 502. A first button 504 is located on the upper surface. A second button 508 is located on a side surface so that it is engaged by the user's thumb. The second button 508 can have the same function as the first button. This allows the user the freedom to alternate between the first and second buttons. The first button can be placed to engage the middle or proximal section of the finger as shown in FIG. 5a or the button 534 can be placed to engage the distal segment of the finger as shown in FIG. 5B. This unique embodiment provides some relief for users with finger pain. In this embodiment, the user must make a motion that is substantially parallel with the work surface. Finally, FIG. 5C illustrates a mouse 540 that uses two buttons on the side surface in place of the upper surface.

The description of the present invention has been presented for purposes of illustration and description, but is not limited to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated

I claim:

1. An improved computer pointing device comprising:
(a) a movement detector located in a body having an upper surface;
(b) at least one button located on the upper surface so that it is engaged by a proximal segment of a user's finger.

2. The pointing device of claim 1 wherein the at least one button is located to engage the proximal segment of the user's index finger.

3. The pointing device of claim 1 wherein the at least one button is located to engage the proximal segment of the user's middle finger.

4. The pointing device of claim 1 further comprises an integrated wrist support.

5. The pointing device of claim 4 wherein the wrist support can move relative to the pointing device.

6. The pointing device of claim 4 wherein the wrist support comprises of at least one roller.

7. The pointing device of claim 1 further comprises a cord for coupling the pointing device to a computer, wherein the cord enters the pointing device near a center on the upper surface.

8. The pointing device of claim 7 wherein the cord is lifted from the upper surface by a guide.

9. The pointing device of claim 8 wherein guide is stowable into a groove on the upper surface.

10. The pointing device of claim 1 further comprises a wireless transmitter to couple the pointing device to the computer.

11. The pointing device of claim 1 further comprises a roller wheel.

12. An improved computer pointing device comprising:
(a) a movement detector located in a body having an upper surface;
(b) at least one button located on the upper surface so that it is engaged by a proximal segment of a user's finger; and
(c) at least one button located on a side surface of the body.

13. The pointing device of claim 12 wherein the upper surface button and the side surface button offer the same functionality.

14. The pointing device of claim 12 further comprises an integrated wrist support.

15. The pointing device of claim 14 wherein the wrist support can move relative to the pointing device.

16. The pointing device of claim 12 further comprises a cord for coupling the pointing device to a computer, wherein the cord enters the pointing device near a center on the upper surface.

17. The pointing device of claim 16 wherein the cord is lifted from the upper surface by a guide.

18. The pointing device of claim 17 wherein guide is stowable into a groove on the upper surface.

19. An improved computer pointing device comprising,
(a) a movement detector located in a body having an upper surface;
(b) a cord connecting the pointing device to a computer, wherein the cord is coupled to the body near the center of the upper surface.

20. The improved computer pointing device of claim 19 further comprises:
(c) a guide for lifting the cord away from a user's hand.

21. The improved computer pointing device of claim 20 wherein the guide is rigid.

22. The improved computer pointing device of claim 20 wherein the guide is a tube that envelopes the cord.

23. The improved computer pointing device of claim 20 further comprises a swivel portion.
